(19) United States
(12) Patent Application Publication
(10) Pub. No.: US 2008/0164128 A1
(43) Pub. Date: Jul. 10, 2008

(54) Double Side-Bar Conveyor or Digger Chain

(76) Inventor: Max H. Ririe, Idaho Falls, ID (US)

Correspondence Address: KIRTON AND MCCONKIE, 60 EAST SOUTH TEMPLE,, SUITE 1800, SALT LAKE CITY, UT, 84111, US

(21) Appl. No.: 11/621,787

(22) Filed: Jan. 10, 2007

(51) Int. Cl. B65G 17/06

(52) U.S. Cl. 198/853

(57) ABSTRACT

An agricultural conveyor chain with links is disclosed, each link including a rod connected on either end to a pair of side bars, each side bar having a circular hole and a keyhole and the pair of side bars forming a Y shape to interact with the rod and side bars of the next link. The connection between the rod and side bars is provided by notches in the rod that interact with the narrow ends of keyholes in the side bars. Each rod also interacts with the circular hole of the side bars from the next link, and a nut and bolt in the pair of side bars prevents the rod from sliding out of the narrow end of the keyholes. This provides a rotatable but secure linkage between links, simple repairs, and ends of the rods that are substantially flush with the outside of the side bars.

### BACKGROUND OF THE INVENTION

1. Field of the Invention

The present invention relates to a conveyor chain for use in potato harvesters and other similar agricultural harvesting machines, and more particularly to such a conveyor chain having spaced material supporting flight rods and articulated connecting links which hold the supporting rods in assembly by pairs of side bars on each end of the flight rods.

2. Background and Related Art

Conventional conveyor chains employed on potato harvesters and the like usually consist of a plurality of elongated spaced flight rods interconnected at their opposite ends by sets of continuous chains of articulated links. The rods usually employ large flanged integral heads, removable lock nuts, cotter keys, or other similar constraining devices to prevent the links from sliding off the ends of the rods. The assembly of such constraining devices is tedious and time-consuming, and frequently no provision is made for limiting inward movement of the links on the rods. When such movement occurs, the ends of the rods protrude outwardly of the sides of the chain where they are exposed to damage by or to cause damage by catching on adjacent conveyor supporting structure or becoming entangled with vines, weeds, and other trash pulled into the conveyor. Also during such inward displacement, the links are subject to being damaged from engagement with drive sprockets, idlers, or other conveyor supporting structure.

There are also conventional conveyor chains using spaced flight rods having opposite ends interconnected by hooks. These chains are characterized by entanglement with crops and debris during operation, lack of desired durability, a tendency to misalign and to incur accompanying stress and wear as well as to impose undue stress and wear on the mounting sprockets therefore.

There are also conventional conveyors using belts to secure the flight rods. These belts are typically weaker than the chains, and require a different type of linkage where belt elements are joined, and the linkage typically forms a weak spot in the belt that is even more prone to failure.

Each of the conventional conveyors, whether using belts or chains, has other difficulties beyond those described above. It sometimes occurs that the rods on the conveyor or digger become damaged and require replacement. On many of the conveyors, changing out damaged flight rods or other damaged parts is so impractical that it is simpler to always carry an extra conveyor belt or chain, and when damage occurs replace the entire belt or chain. The damaged belt or chain is then transported back to a workshop and repaired. Repairs often require the use of special tools and may be extremely labor intensive. Some parts may even be welded, requiring torching off of welded parts. Additionally, many conventional conveyors use a large multitude of specialized parts or require the replacement of large sections when even a small portion of the conveyor is damaged. Each of these problems can greatly increase the cost of using the conveyor in harvesting.

### BRIEF SUMMARY OF THE INVENTION

The present invention provides a novel digger chain or conveyor chain for use on harvesting and handling equipment used on potatoes, sugar beets, onions, and other agricultural products. The conveyor chain addresses the shortcomings of the traditional conveyor or digger chains and belts. The purpose of the chain is to convey the crop while simultaneously separating the dirt from the crop and allowing the dirt to fall through the gaps between rods in the chain. Thus the crop is contained and conveyed for transport, and the dirt and debris is left in the field. The conveyor chain or digger chain has linkage elements on each end of a series of bars or rods, forming a ladder-like appearance, with the spacing of the rungs of the ladder (the bars) chosen so as to ensure that the crop cannot fall through the conveyor chain bars.

The novel conveyor chain has three elements: a side bar, with four side bars per link, a rod, with one rod per link, and a keeper element such as two small bolts and nuts per link. Each side bar has a pair of holes in it: a circular hole and a keyhole. The rod has notches on each end to fit tightly into the keyhole in the sidebar, and is able to rotatably pass through the circular hole in the side bar. To assemble a length of conveyor chain, a pair of sidebars is placed together on each end of the bar, and the bar is rotated so that the notch in the bar allows the rod to be forced into the narrow end of the keyhole. The notch secures the pair of side bars together, and the side bars are further secured using the keeper element such as the bolts and nuts. The rod is also passed through the circular hole of the side bars for the next link in the chain, and each bolt and nut engage the edge of the side bars from the next link in the chain and prevents the rod from sliding out of the narrow end of the keyhole.

Because of this construction, the conveyor chain can be easily repaired in the field with a minimum of tools. Specifically, a rod can be removed by merely using wrenches or other tools to loosen and/or remove a single link's keeper element, then the link can be rotated 90 degrees and the rod may then be moved into the wide end of the keyhole and easily removed and replaced. Since all the links in the chain are identical, any damaged rod or other damaged part may be easily removed and replaced in the field with a minimum of tools and time, and with a minimum of spare parts required. The simple construction reduces cost, and the savings in time for repairs also provides great cost benefits. The ends of the chain are smooth, preventing damage to the inside of the conveyor. Additionally, damage to crops is minimized when compared to hook chain coveyors.

To facilitate ease of assembly, pairs of side bars may be permanently connected together. The side bars may be welded or spot welded together, and this reduces the number of individual parts to be handled in assembly and has no effect on the performance of the chain. Although the described conveyor chain is particularly suitable for use in agricultural situations, those of skill in the art may readily appreciate that the chain conveyor may be adapted for use in other situations where a conveyor having flight rods is desirable.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1a shows a side plan view of an embodiment of a side bar for use in the present invention;

FIG. 1b shows a top plan view of the embodiment of FIG. 1;

FIG. 2a shows a plan view of an embodiment of a rod for use in the present invention;

FIG. 2b shows a section view of the rod from FIG. 2a taken along the line 2b-2b;

FIG. 3 shows a plan view of a pair of side bars engaged with a rod;

FIG. 4 shows a plan view of a series of side bars and rods forming links in a conveyor chain;

FIG. 5 shows a plan view of a series of side bars and rods looking along the long axis of the rods;

FIG. 6 shows a plan view of a series of side bars and rods looking along the long axis of the rods, with one of the side bars rotated 90 degrees;

FIGS. 7a-7c show plan views of an embodiment of a side bar;

FIG. 8 shows a plan view of an embodiment of a rod;

FIGS. 9a-9b show plan views of an alternate embodiment of a side bar and keeper element; and

FIGS. 10a-10c show plan views of another alternate embodiment of a side bar and keeper element.

### DETAILED DESCRIPTION OF THE INVENTION

Referring now to the Figures, a description of the embodiments of the present invention will be given. It is expected that the present invention may take many other forms and shapes, hence the following disclosure is intended to be illustrative and not limiting, and the scope of the invention should be determined by reference to the appended claims.

In the specification and in the claims, the terms “chain,” “conveyor chain,” and “digger chain” shall be synonymous and interchangeable. The terms “rod” and “flight rod” shall be synonymous and interchangeable, and may refer to rods of any length and diameter, and also may include rods of varying materials and strengths.

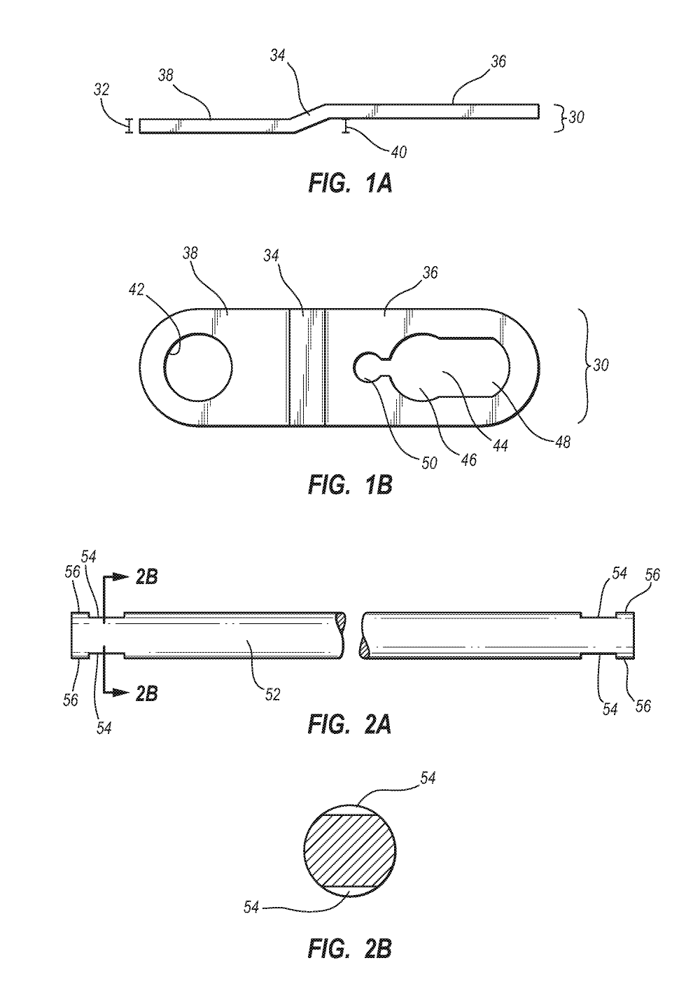

FIGS. 1a and 1b show side and top views of a side bar 30 in accordance with one embodiment of the present invention. The side bar 30 is manufactured from a durable material sufficiently strong to hold up to the rigors of use as the linking member of a conveyor chain. Typically, the side bar 30 is made of metal, such as steel. The steel may be carburized and hardened to increase durability and strength. In situations where durability is less of an issue, other materials such as hard plastic or certain durable ceramics may be chosen to provide certain manufacturing advantages and lightness, such as where the conveyor chains is used for a non-agricultural conveyor. As may be seen in FIG. 1a, the side bar 30 has a thickness 32. The side bar also has a jog 34 near to, but offset from, the middle of the side bar 30. The jog 34 is clearly visible in the side view of FIG. 1a. The side bar 30 is substantially planar on either side of the jog 34, thus forming a large planar portion 36 and a small planar portion 38, and the two substantially planar portions 36,38 are substantially parallel in orientation. The jog 34 thus displaces the one substantially planar portion relative to the other a jog distance 40, and the jog distance 40 is chosen to be slightly larger than the thickness 32 of the side bar 30, for reasons that will become apparent later.

As may be seen in FIG. 1b, the side bar 30 has several openings or holes passing through the side bar 30, perpendicular to the planes of the planar portions 36, 38. There is a circular hole 42 passing through the small planar portion 38 and a irregular keyhole 44 passing through the large planar portion 36. The keyhole 44 has three primary portions to it: a large circular portion 46, a flat-sided portion 48 and a small circular portion 50. The circular hole 42 and the large circular portion 46 of the keyhole 44 are sized to rotatably accept a circular or cylindrical end of a rod (not shown), such that the diameter of the rod is too large to pass into either the flat-sided portion 48 or the small circular portion 50.

FIGS. 2a and 2b show a substantially cylindrical rod 52 for use with the side bar 30. The rod 52 is also manufactured of a material sufficiently strong to hold up to the rigors of use as a member of a conveyor chain, as is described above in reference to the side bar 30. The rod 52 may be made of a material such as steel which has been drawn and hardened to increase its strength and resistance to wear.

The rod 52 has a pair of notches 54 near each end of the rod 52. As may be seen from FIG. 2b which is a cross-sectional view of the rod 52 taken along the line 2b-2b from FIG. 2a, the notches 54 are flat-sided indentations on either side of the rod 52. The notches 54 are deep enough so that the flat sides of the notches 54 snugly fit within the flat-sided portion 50 of the side bar 30. Thus the side bar 30 may pass freely over the end of the rod 52 at either the circular hole 42 or the large circular portion 46 of the keyhole 44. The keyhole 44 of the side bar 30 is thus passed over the end of the rod 52 until the notches 54 at one end of the rod 52 are aligned with the side bar 30. If the rod 52 is in the circular hole 42, the notches 54 make no difference in how the rod 52 rotates in the circular hole 42. However, if the rod 52 is in the large circular portion 46 of the keyhole 44, the rod may be rotated until the flat sides of the notches 54 are parallel to the flat sides of the flat-sided portion 48 of the keyhole 44, and the rod 52 may slide into the flat-sided portion 48 of the keyhole 44. The flat sides of the notches 54 and the flat-sided portion 48 then interact, preventing axial rotation of the rod 52, and the substantially cylindrical portions of the rod 52 on either side of the notches 54 prevent large lateral movements of the rod 52 relative to the side bar 30.

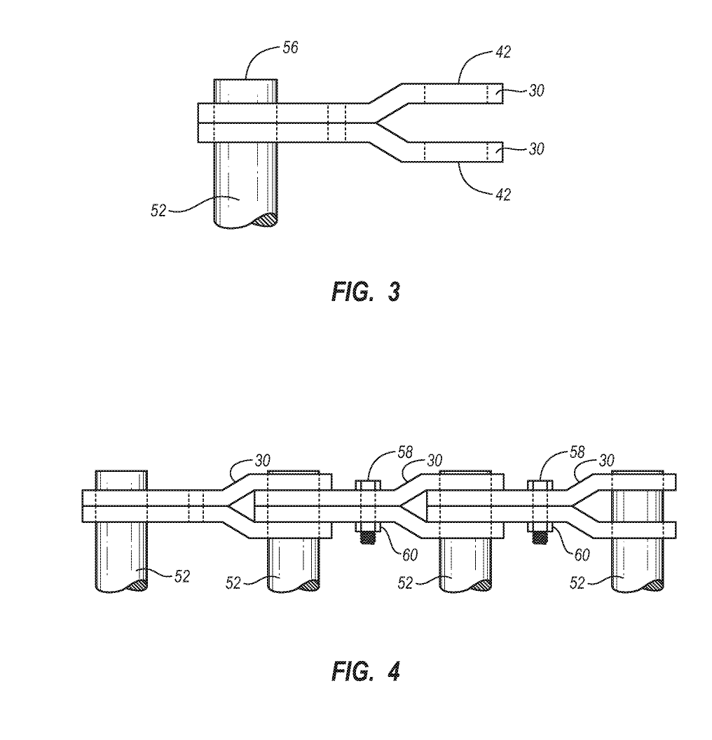

If only one side bar 30 is in the notches 54 at one end of the rod 52, however, a fair amount of lateral movement of the side bar 30 is possible. This is because the width of the notches 54 is chosen so as to be slightly larger than twice the thickness 32 of the side bar 30. This allows the notches 54 to accommodate two side bars 30, as may be seen in FIG. 3. As may also be seen from FIG. 3, the rod 52 has an end portion 56 beyond the notches 54 that extends approximately at least as far as the thickness 32 of the side bar 30. When the end portion 56 and the notches 54 engage the flat-sided portion 48 of the keyhole 44 of the two side bars 30, as shown in FIG. 3, the rod 52 and the two side bars 30 are essentially locked together, so that the rod 52 may no longer rotate about its long axis relative to the side bars 30, and the side bars 30 may move only minimally in a direction tangential to the long axis of the rod 52. This engagement also holds the two side bars 30 together in the configuration shown in FIG. 3. This configuration, when mirrored at the other end of the rod 52 provides one link in the conveyor or digger chain. The only movement of the side bars 30 relative to the rod 52 that is less restricted is the movement of the rod 52 rightward in FIG. 3 relative to the side bars 30, so as to be positioned in the large circular portion 46 of the keyhole 44. Even then, the size of the notches 54 and the flat-sided portion 48 may be chosen to provide a tight frictional fit that holds the rod 52 in place when in the flat-sided portion 48.

In use as a part of a conveyor chain, this rightward movement of the rod 52 relative to the side bars 30, is undesirable except when a rod 52 or side bar 30 has been damaged and needs replacing. This unwanted movement is limited by the interaction of one link in the conveyor chain with the next link in the conveyor chain, as will become apparent in reference to FIG. 4. FIG. 4 shows several consecutive links in the conveyor chain. Of course, to complete the links, a similar and symmetrical, though mirror-image, set of links would be provided at the opposite end of the rods 52. The hinged connection between links is provided by the engagement of the rods 52 with a sandwich of four side bars 30. The notches 54 prevent rotation of the rods 52 relative to the side bars 30 which are the inner two of the sandwich of four side bars 30. However, the outer two of the side bars 30 interact with the rods 52 at the circular hole 42, allowing the outer set of side bars 30 to rotate approximately 180 degrees (90 degrees in each direction from the position shown) or more about the long axis of the rods 52. This provides the conveyor chain with its needed flexibility. In fact, this connection is typically even more flexible than is needed to provide a conveyor chain. This flexibility also serves to provide easy interchanging of damaged parts at any link in the chain, as will be described below.

As may be appreciated from FIG. 4, each completed link in the conveyor chain includes one additional feature, namely a keeper element. In the embodiment shown in FIG. 4, the keeper element is a small bolt 58 and a small locking nut 60 that are provided for each link, as shown. The bolt 58 passes through the small circular portion 50 of the keyhole, and the nut 60 threads onto the bolt and the nut 60 and bolt 58 are tightened securely. This serves two simultaneous purposes. First, the bolt 58 and nut 60 help secure the pair of side bars 30 together. More importantly, however, the bolt 58 and nut 60 physically engage the side bars 30 of the adjacent link to prevent rightward movement of the adjacent side bars 30 relative to the side bars 30 through which the bolt 58 passes, and they therefore prevent relative rightward movement of the rod 52. This keeps the rod 52 securely locked within the flat-sided portion 48 of the keyhole 44. In this fashion, an entire conveyor chain may be provided with identical links, each secured by the notches 54 in the rod 52 and by the bolts 58 and nuts 60. Each link in a conveyor chain in the depicted embodiment is formed by one rod 52 and four side bars 30, two bolts 58, and two nuts 60, with one half for each end of the rod 52.

The outer pair of side bars 30 at each link cannot scissor apart to pass the bolt 58 and nut 60 of the inner side bars 30 and thus release the rod 52 rightward because the notches 54 and bolt 58 and nut 60 of the outer pair of side bars 30 hold the side bars 30 together. This ensures that the linkage is very secure and very unlikely to undesirably release during operation or normal handling. This security of the linkage is furthered by two factors. First, the nut 60 is typically selected so as to be a locking nut of the type that does not readily loosen or fall off unless that is the desired action. Second, the conveyor chain in use is typically under tension in a lengthening direction, which provides additional assurance that the notches 54 of the rods 52 will stay securely in the flat-sided portions 48 of the keyholes 44 of the side bars 30.

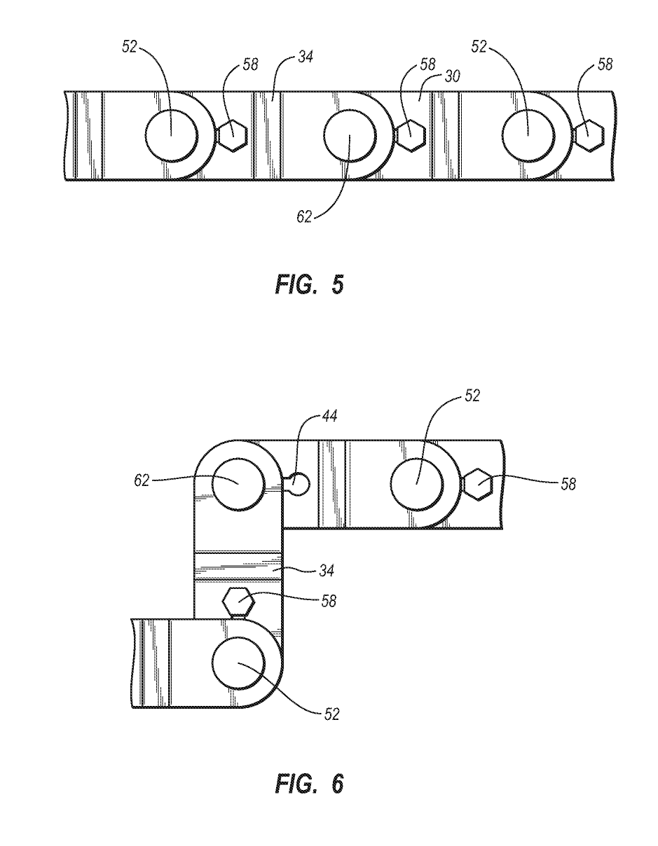

When using any conveyor chain or digger chain, it is not uncommon for the rods 52 of the chain, or even the side linkage members to become damaged. This is where the current linkage provides special advantages over current chains. With the current inventive chain, the damaged rod or section can easily and quickly be removed and replaced in the field with only a few common tools. The repair can be effectuated regardless to which link in the chain is damaged, and even if multiple links are damaged. The replacement requires only a few spare parts, and not an entire replacement chain. How the repair is done will be described with reference to FIGS. 5 and 6 for the previously-described embodiment.

FIG. 5 shows a perspective view of a link in the conveyor chain looking down the long axis of one of the rods 52. This view shows how the bolts 58 as well as the jogs 34 of the side bars 30 prevent rightward movement of the rods 52 in the keyholes 44. If one of the rods 52 is a damaged rod 62 and needs to be replaced, the adjacent bolt 58 is loosened using a standard wrench or pair of wrenches and the bolt 58 and nut 60 are removed so as to no longer impinge upon the rightward movement of the damaged rod 62. However, as may be appreciated by reference to FIG. 5 where the outline of the underlying side bar 30 is provided, the rightward movement of the damaged rod 62 is still prevented by the interference of the adjacent jog 34 of the outer side bars 30 with the edge of the inner side bars 30. To remove this interference, the links and side bars 30 through which the damaged rod 62 passes are rotated 90 degrees to assume the configuration shown in FIG. 6.

Once the links have been rotated 90 degrees, the jog 34 of the outer sidebars 30 no longer restricts the rightward movement of the damaged rod 62 relative to the inner sidebars 30, and the damaged rod 62 may be moved rightward until the notches 54 (not shown) no longer engage the sides of the keyhole 44 and the damaged rod 62 may be pushed or pulled out of the side bars 30 along its long axis (into or out of the plane of FIGS. 5 and 6) until it is may be completely removed from one side of the conveyor chain, and then the other. Then, a replacement rod 52 may be inserted and secured by reversing the steps described above. Depending on the tightness of the fit of the rod 52 or damaged rod 62, as well as the condition of the conveyor chain (which may become dirty or coated with grime in use), a hammer may be needed to drive the rod 52 or damaged rod 62 rightward (or leftward) in the keyhole 44 or into or out of the side bars 30 (into or out of the plane of FIGS. 5 and 6).

Thus the current inventive chain and linkage provides for simple and quick changing of damaged parts while still in the field. In fact, as may be appreciated by reference to FIG. 6, only a minimal amount of slack is required in the conveyor chain to remove a damaged rod 62. This means that a damaged conveyor chain may be left on the machine, a minimal amount of slack may be provided, and the damage quickly repaired. The slack in the conveyor chain may then be taken out and work resumed. Only a minimal amount of labor is required for the change, and only a minimal amount of time is required to make the repair. Since only a few spare parts and tools are needed instead of an entire replacement chain, the amount of repair materials to be carried around is greatly reduced. Thus the agricultural machines using or relying on the chain are only interrupted for a minimal time, improving efficiency in the field.

Although less common, if a side bar 30 is damaged, then two links are removed (at least temporarily) to replace it, as may be appreciated by reference to FIG. 6. Similarly, if a larger section of chain is damaged, a link is simply removed from either end of the damaged portion and the damaged portion is removed completely. Then a section to replace the damaged portion is assembled and inserted following the same procedures. In fact, because the chain is so flexible, a small section of chain may be wound around itself and carried to provide spare parts. When a replacement part is needed, that part may be removed from the spare section of chain as described above and used for the repair, whether a section of chain or just a rod. This helps prevent lost spare parts. Thus any size of repair may be made simply and easily using the present invention. No additional slack is required, since once one link is removed, additional slack may be provided to remove the other links by the removal of the first link. The changing procedure is completely scalable to allow any size of repair. In addition, should it be needed, the conveyor chain may be shortened or lengthened easily and simply by removing a link and adding or excising a section. Thus, this conveyor chain assembly is highly flexible.

As may be appreciated by reference to FIG. 5, a small gap exists between the bolt 58 and nut 60 and the adjacent side bar 30. While this small gap does not allow enough movement of the adjacent side bar 30 and rod 52 to release the rod from the flat-sided portion 50 of the keyhole 44, it does allow access to the bolt 58 and nut 60 to permit them to be loosened or tightened.

Other advantages of the inventive conveyor chain may be appreciated by reference to FIGS. 3 and 4. Because the end portion 56 of the rod 52 is chosen to be approximately the thickness of the side bar 30, when the conveyor chain is assembled, the rods 52 do not protrude or only protrude minimally beyond the side bars 30. This minimizes the possibility of damage to the conveyor equipment, as there are no externally-protruding parts to catch on the equipment. This also reduces the risk of harm to equipment operators.

While one embodiment of the inventive side bar conveyor chain has been described, it is anticipated that changes may be advantageously provided while still falling within the spirit of the invention. For example, while the chain has been described as having side bars 30 on either end of the rod 52, it is anticipated that the side bars 30 and notches 54 of the rods 52 may be additionally provided at other locations of the rods 52. If, for example, a particularly wide span for the conveyor chain is desired, it may be desirable to provide an additional side bar chain in the middle of the rods 52 for stability. As another example, the side bars 30 need not be provided at the extreme ends of the rods 52, but may be provided inset to some degree, with some portion of the rods 52 protruding beyond the side bars 30.

While the bolt 58 and nut 60 have been described and shown in FIG. 4 with the nut 60 on the interior of the side bars 30, the function of the side bars is unaffected by reversing the direction of the bolt 58 and nut 60 so that the nut 60 lies on the exterior of the side bar conveyor chain. The bolt 58 and nut 60 may even be replaced by some other fastening means known in the art. For example, a type of pop rivet could be provided instead of a bolt 58 and nut 60. While this would probably require a drill to remove, it would reduce the potential for inadvertent loosening of the nut 60 resulting in loss of the securing mechanism. Although the keyhole 44 has been described as a single hole with three portions, it is anticipated that the small circular portion 50 which accepts the bolt, rivet, or other means for locking the position of the rod might be provided as a separate hole rather than as a portion of the larger keyhole 44.

It is further anticipated that in some instances a different locking mechanism could be provided. For example, as described above with reference to FIG. 5, the rightward movement of the rod 52 in the keyhole 44 relative to the side bar 30 is impinged by the jog 34 and the natural tensioned state of the conveyor chain. Because of this, the bolt 58 and nut 60 (as well as the small circular portion 50 of the keyhole 44) may be removed completely in some embodiments. While this reduces the security of the connections of the chain when the chain is in a slackened state, it has no effect on the primary functionality of the chain in its normal use state, and further simplifies the changing and repair process, as no tools (beyond possibly a hammer, as described above) are required. In such an embodiment, the fitting between the notches 54 and the flat-sided portion 48 of the keyhole 44 may be chosen to provide an extremely tight fit to provide the securing mechanism, or may even be slightly shaped to ensure a better, more-secure locking fit even without the separate bolt 58 and nut 60. In any embodiment where a separate means for locking the pairs of side bars 30 together is not provided, the notches 54 of the rod 52 may serve as a means for securing the pairs of side bars 30 together.

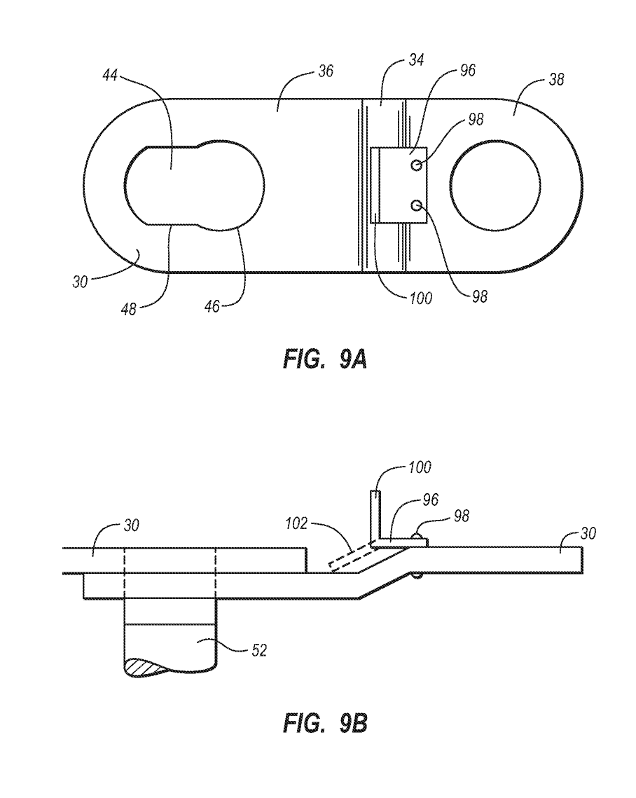

Other different keeper elements may also be provided to keep the rods 52 contained in the flat-sided portions 48. For example, referring to FIG. 9a, an alternate embodiment of the side bar 30 is shown. In this embodiment, the side bar 30 is shorter to provide a smaller gap between flight rods 52. However, this shortening of the side bar 30 prevents ready access to a bolt 58 and nut 60 as depicted with reference to FIGS. 4-6. Therefore, the small circular portion 50 has been omitted from the keyhole 44. Instead, a deformable keeper plate 96 may be used to act as the keeper element. In the embodiment shown in FIG. 9a, the keeper plate 96 is attached to the small planar portion 38, although it is envisioned that the keeper plate 96 may be attached to the jog 34 or the large planar portion 36 in other embodiments of the side bar 30. In the embodiment shown, the keeper plate 96 is attached using rivets 98, although other methods such as welding or spot welding are possible to attach the keeper plate 96 to the side bar 30. Rivets 98 are advantageous in that they are easily replaceable by drilling out and re-attaching new rivets if the keeper plate 96 breaks or otherwise needs replacement.

The keeper plate 96 shown in FIG. 9a has a keeper tab 100 which may be bent or deformed so as to engage the rod 52 or side bar 30 of the adjacent link to prevent the rod 52 from leaving the flat-sided portion 48 of the keyhole 44. This may be appreciated by referring to FIG. 9b, which shows how the keeper tab 100 may be bent so as to engage the adjacent side bar 30 to prevent the rod 52 from leaving the flat-sided portion. In some embodiments, the keeper tab 100 may be extended so as to engage the rod 52 itself (particularly for embodiments where the keeper plate 96 is installed on an inner side bar 30, or for embodiments where the rods 52 extend beyond the side bars 30) instead of the side bar 30.

The keeper plate 96 has several advantages over the bolt 58 and nut 60 previously depicted, in that the tools to be used to replace rods may be simplified to a hammer and possibly pliers to bend the keeper tab 100 into and out of its engaging position 102. It can sometimes be relatively less advantageous, however, after repeated use, if flexing of the keeper tab 100 leads to material fatigue and breaking of the keeper plate 96 requiring replacement of the keeper plate 96, in that the keeper plate 96 is somewhat more difficult to replace than are the bolt 58 and nut 60. Such material fatigue is minimized by reducing the amount of flexing necessary to move the keeper tab 100 into and out of the engaging position 102. Thus, while the keeper plate 96 has been illustrated in FIGS. 9a-9b as having a significant bend forming the keeper tab 100, those of skill in the art will recognize that only enough bending is required so as to move the keeper tab 100 from impinging upon the movement of the rod 52 into the large circular portion 46. It may be readily appreciated that this type of keeper element may also be used in lieu of the bolt 58 and nut 60 in embodiments with longer side bars 30.

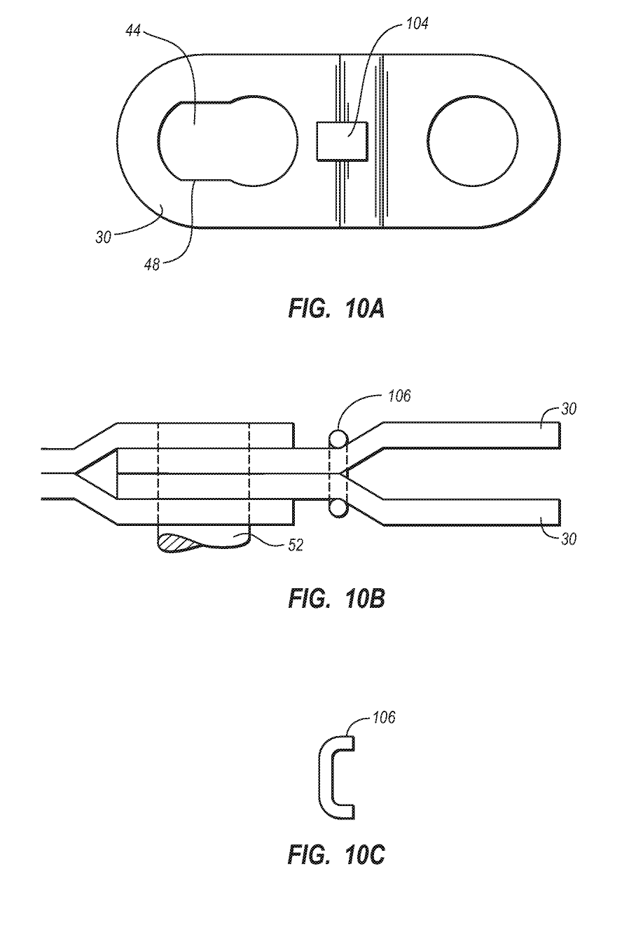

Another embodiment of the side bar 30 and keeper element is depicted in FIGS. 10a-10c. This embodiment is particularly flexible in use, and may be preferred by some farmers as no special equipment is required. In this embodiment, the side bar 30, also depicted as being a short side bar 30 but capable of use with longer side bars 30, lacks the small circular portion 50 of the keyhole 44. Instead, the side bar 30 is provided with a notch 104 or hole. The notch 104 is sized and located to accept a short piece of wire 106 which may be inserted into the notch 104 and then bent into the shape shown in FIGS. 10b and 10c so as to prevent unwanted lateral movement of the adjacent side bar 30.

As the typical forces that would tend to disengage the rod 52 from the flat-sided portion 48 when not desired are small, the wire 106 need not be particularly thick or strong, and may even be typical baling wire commonly used and available on farms. Thus, a farmer using the embodiment of the digger chain from FIGS. 10a-10c need merely carry a pair of pliers with a wire cutter to change a damaged rod, and can use almost any kind of wire commonly available on a farm to serve as the wire 106. Additionally, if the wire 106 is lost or broken, a new wire 106 can quickly and easily be cut and bent in place. While the embodiment shown includes one notch 104 and securing wire 106, other embodiments might use multiple notches 104 and securing wires 106. The actual placement of the notch 104 is not deemed important as long as unwanted movement of the rod 52 out of the flat-sided portion 48 is prevented when the wire 106 is place in the notch 104.

While each side bar 30 has been described above as formed out of a single piece of material such as metal, it is anticipated that the side bars 30 may be formed from several pieces of material. For example, one skilled in the art can readily appreciate that the side bars 30 may be made from two pieces, one for each substantially planar portion 36, 38. The two pieces would then be joined with one layered on top of the other to essentially provide the jog 34 and jog distance 40 described in reference to FIG. 1. In this and other manners, the large planar portion 36 need not necessarily be of the same thickness as the small planar portion 38.

Furthermore, while the side bars 30 have been described as individual separate pieces, it is anticipated that for ease of use and simplicity each pair of side bars 30 may be permanently joined together to assume the paired shape shown in FIG. 3. Thus, two side bars 30 may be placed next to one another and welded or spot welded together to form the Y shape shown. Other means of permanently or semi-permanently joining the side bars 30 may also be used, as long as they do not interfere with the rotating functions of the chain. The paired side bars 30 may even be manufactured as a single piece rather than as two separate and then joined pieces. Since side bars 30 are used in pairs in the manner described, this would simplify the construction and repair process, as pairs of side bars 30 would always be properly aligned to receive the rods 52, and the risk of accidentally losing or dropping a side bar 30, or of improperly assembling the conveyor chain would be reduced.

Although the embodiments described have included symmetrical notches 54, with notches 54 on both sides of the rod 52 and with two flat sides of the flat-sided portion 48, it is anticipated that the primary functionality of the invention may be maintained even if only one notch 54 is provided per end of the rod 52. In this case, the rod 52 would not have 180-degree rotational symmetry, and one side of the flat-sided portion 48 may be opened up to accommodate the different shape of the rod 52. In this case, the rod 52 may only fit in the flat-sided portion 48 in one orientation instead of two. It is anticipated that this interaction with a single flat side and a single notch 54 would still provide the necessary functions of locking rotation and translational movement of the rod 52 relative to the side bars 30. The shape of the keyhole 44 and of the single notch 54 in the rod 52 in such an embodiment may be readily appreciated by one of skill in the art from the foregoing description.

Although the description has focused on a double side bar 30 link for a conveyor chain wherein the side bars 30 are doubled to form a Y shape wherein the large planar portions 36 of paired side bars 30 touch and are joined, the primary functionality of the invention may be maintained in embodiments where the Y shape is formed wherein the small planar portions 38 touch and are joined. Although this requires modification of the notches 54 in the rod 52 from that described above, these modifications may be readily appreciated by those skilled in the art.

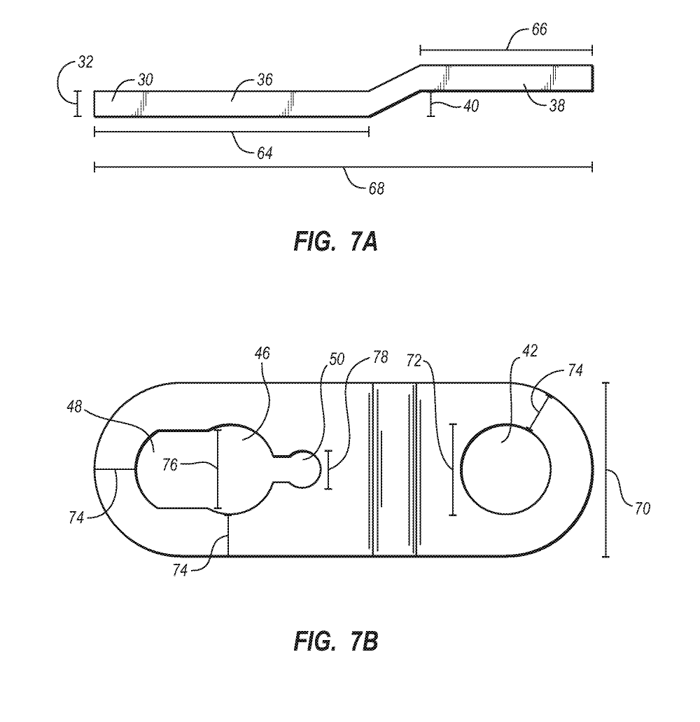

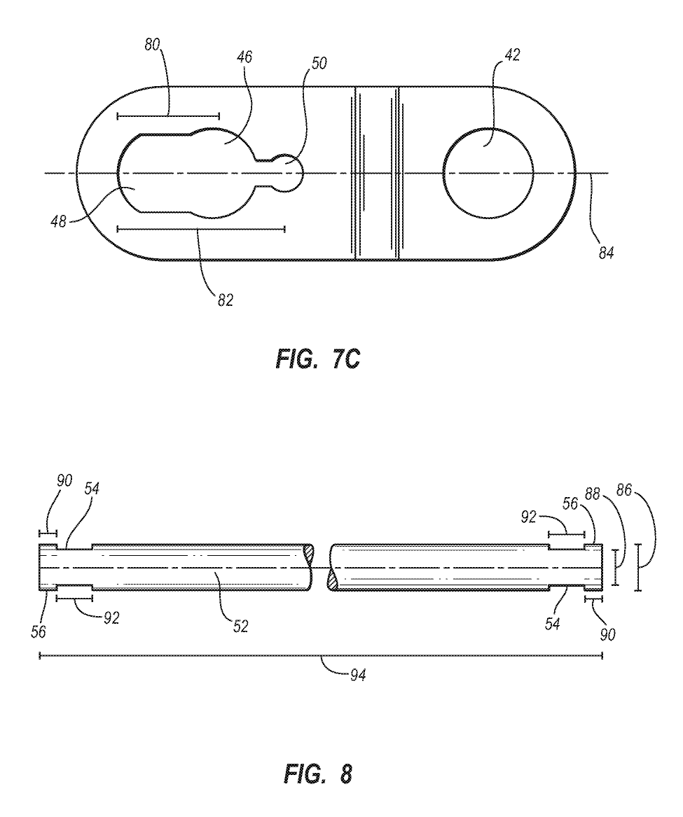

Although it is anticipated that the double side-bar conveyor or digger chain may be manufactured of individual pieces of varying sizes to suit the particular needs of the situation with which it will be used, representative dimensions of one embodiment will be described with reference to FIGS. 7a-7c and 8. FIGS. 7a-7c show the various representative dimensions of the side bar 30 and FIG. 8 shows the representative dimensions of the rod 52. In the following description, manufacturing tolerances of approximately ±0.005 inches is assumed. Referring now to FIG. 7a, the thickness 32 of the sidebar 30 of this embodiment may be 0.160 inches. The jog distance 40 may be 0.170 inches. Of course, the thickness 32 and jog distance 40 may be increased and decreased in tandem with each other and in tandem with the size and placement of the notches 54 in the rod 52 to provide more strength or less weight as desired.

The length 64 of the large planar portion 36 may be 1.500 inches, and the length 66 of the small planar portion 38 may be 1.010 inches. The total length 68 of the side bar 30 in this embodiment is 2.970 inches. This total length will provide for a chain pitch (the spacing between centers of adjacent rods 52) of approximately 1.969 inches or 50 mm. Of course, the total length 68 and the length 64 of the large planar portion 36 may be increased or decreased as desired to provide greater or lesser spacing between adjacent rods 52, as long as the described functionality is maintained.

Referring now to FIG. 7b, the width 70 of the side bar 30 may be 1.000 inch. The diameter 72 of the circular hole 42 and of the large circular portion 46 may be 0.530 inches. This means that the distance 74 between the edge of the side bar 30 and the closest edges of the circular hole 42, the large circular portion 46 and the flat-sided portion 48 may be 0.235 inches. The width 76 of the flat-sided portion 48 may be 0.420 inches. The diameter 78 of the small circular portion 50 may be 0.196 inches, or whatever diameter accommodates the bolt 58 to be used to secure the side bars 30. Referring to FIG. 7c, the distance 80 from the edge of the flat-sided portion 48 along a central axis 84 of the side bar 30 to the center of the large circular portion 46 may be 0.570 inches and the distance 82 from the edge of the flat-sided portion 48 along the central axis 84 of the side bar 30 to the center of the small circular portion 50 may be 1.000 inch.

Referring to FIG. 8, the dimensions of the rod 52 are shown. The diameter 86 of the rod 52 may be 0.500 inches, while the diameter 88 of the rod 52 at the notches 54 may be 0.420 inches. While the majority of the dimensions of the rod 52 and the side bar 30 are chosen to allow free rotation of the rod 52 in the holes, the diameter 88 of the rod 52 at the notches 54 is chosen to be identical to the width 76 of the flat-sided portion 48 (0.420 inches) so as to provide a tight fit when the rod 52 is inserted into the flat-sided portion 48 at the notches 54.

The width 90 of the end portion 56 of the rod 52 may be 0.180 inches, and the width 92 of the notches 54 may be 0.350 inches. The overall length 94 of the rod 52 may be 33.000 inches, or whatever length is desired to provide the desired width of the conveyor.

Use of these dimensions will provide a conveyor or digger chain having a chain pitch of approximately 50 mm or approximately 2 inches, with approximately 1.5 inches of space between adjacent rods 52. As mentioned, these dimensions could be changed to change the chain pitch and spacing, and they may also be changed to provide greater strength to the conveyor chain. Furthermore, the dimensions could be changed, if strength is less of an issue, to provide a lighter and smaller conveyor chain.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A conveyor chain comprising
a linking element, the linking element comprising:
double side bars forming a Y shape, each side bar comprising a jog, a circular hole, and a keyhole, the keyhole comprising:
a circular portion; and
a flat-sided portion; and
means for securing the two side bars of the double side bars together; and
a flight rod engaging the double side bars comprising notches in the flight rod that engage the double side bars at the flat-sided portions of the keyholes.

2. A conveyor chain as in claim 1 further comprising:
an additional hole in each side bar adjacent the keyhole and sized to accept a small bolt;
a small bolt passing through the additional hole; and
a small nut attached to the small bolt, wherein the bolt and nut engage the side bars of an adjacent linking element and prevent the flight rod from disengaging the flat-sided portion of the keyhole.

3. A conveyor chain as in claim 1 further comprising:
a notch in each side bar adjacent the keyhole and sized to accept a piece of wire;
a short piece of wire passing through the notch and bent so as to remain in the notch, wherein the short piece of wire engages the side bars of an adjacent linking element and prevent the flight rod from disengaging the flat-sided portion of the keyhole.

4. A conveyor chain as in claim 1 further comprising a keeper plate attached to at least one of the side bars of each double side bar forming a Y shape, the keeper plate comprising an attachment portion and a deformable tab portion, wherein the deformable tab portion may be deformed so as to engage at least one of an adjacent side bar and an adjacent flight rod to prevent the flight rod from disengaging the flat-sided portion of the keyhole.

5. A conveyor chain as in claim 1 wherein the flight rod comprises an end and the side bars comprise an outside surface, and the end of the flight rod is substantially flush with the outside surface of the side bars.

6. A conveyor chain as in claim 1 wherein the flight rod and linking element may be removed in the field by a farm hand using simple tools, and replaced in minimum time.

7. A conveyor chain as in claim 1 wherein the double side bars comprise two individual side bars permanently joined, as by welding.

8. A conveyor chain as in claim 1 wherein the keyhole further comprises a small circular portion sized to accept a locking element and wherein the conveyor chain further comprises a locking element within the small circular portion of the keyhole, the locking element selected from the group consisting of a rivet, a wire, and a bolt with a nut.

9. A conveyor chain as in claim 1 wherein the flight rod and a pair of linking elements comprise a single link, and the conveyor chain comprises a plurality of identical said links.

10. A conveyor chain as in claim 1 wherein the rod and the side bars are made of metal.

11. A conveyor chain as in claim 10 wherein the metal is hardened steel.

12. A conveyor chain comprising:
a plurality of elongated rods, each rod comprising:
two ends;
a middle between the two ends;
a substantially-cylindrical end portion at each of the ends of the rod; and
four notches of substantially equal size and shape placed in the curved surface of the substantially-cylindrical end portions, with a pair of notches located near each end of the rod, each notch having a substantially-planar bottom and substantially-planar sides, the substantially-planar bottoms of the notches being substantially parallel; and
a plurality of side bars engaging the rods, each side bar having a thickness and comprising:
a first substantially-planar portion containing a circular hole sized to allow the substantially-cylindrical end portion of the rod to rotatably rest therein; and
a second substantially-planar portion connected to the first substantially-planar portion, substantially parallel to the first substantially-planar portion, and offset from the first substantially-planar portion a distance at least equal to the thickness of the side bar,
the second substantially-planar portion containing a keyhole, the keyhole comprising:
a circular portion sized to allow the substantially-cylindrical end portion of the rod to rotatably rest therein; and
a flat-sided portion sized to tightly engage the notches of the rod so that when the flat-sided portion engages the notches of the rod the flat-sided portion prevents rotation of the rod relative to the side bar.

13. The conveyor chain of claim 12 wherein four side bars engage each end of the rods in pairs to provide a rotatable link that rotates about the substantially-cylindrical end portion of each rod, and wherein each pair of side bars engaging each end of the rods also engage the end of an adjacent rod.

14. The conveyor chain of claim 13 wherein one pair of side bars engaging one end of one rod freely rotates about the rod and wherein the other pair of side bars engaging the one end of the one rod cannot rotate about the rod.

15. They conveyor chain of claim 12 wherein the side bars are paired to form a Y shape.

16. The conveyor chain of claim 12 wherein the plurality of rods and the plurality of side bars form a continuous loop.

17. The conveyor chain of claim 12:
wherein the side bars have an outside surface;
wherein the width of the notches is substantially equal to, to slightly larger than, twice the thickness of the side bars; and
wherein the notches are placed a distance from the end of the side bars substantially equal to, to slightly larger than, the thickness of the side bars so as to provide that the ends of the rods are substantially flush with the outside surface of the side bars.

18. The conveyor chain of claim 12 wherein the rods can be removed in the field using simple tools and replaced in minimal time.

19. The conveyor chain of claim 12 further comprising:
a small circular hole in the second substantially-planar portion of the side bar sized to accept a bolt;
a bolt positioned in the small circular hole to engage an adjacent side bar and prevent the rod from disengaging the flat-sided portion of the keyhole; and
a locking nut attached to the bolt and engaging an adjacent side bar not being engaged by the bolt to further prevent the rod from disengaging the flat-sided portion of the keyhole.

20. The conveyor chain of claim 12 further comprising:
a notch in the side bar sized to accept a wire; and
a short wire positioned in the notch and bent to remain in the notch and engage an adjacent side bar and prevent the rod from disengaging the flat-sided portion of the keyhole.
